(19) United States
(12) Patent Application Publication
(10) Pub. No.: US 2015/0062794 A1
(43) Pub. Date: Mar. 5, 2015

(54) ELECTRONIC APPARATUS

(71) Applicant: KABUSHIKI KAISHA TOSHIBA, Tokyo (JP)

(72) Inventors: Yuichi Hirai, Hamura-shi (JP); Tomohiro Hamada, Tachikawa-shi (JP); Kazuo Ito, Mitaka-shi (JP); Motoki Tomita, Hamura-shi (JP)

(73) Assignee: KABUSHIKI KAISHA TOSHIBA, Tokyo (JP)

(21) Appl. No.: 14/243,286

(22) Filed: Apr. 2, 2014

(30) Foreign Application Priority Data
Aug. 30, 2013 (JP) 2013-179861

(51) Int. Cl. G06F 1/16

(52) U.S. Cl. CPC G06F 1/1681; G06F 1/1637
USPC 361/679.27; 361/679.55

(57) ABSTRACT

According to one embodiment, an electronic apparatus includes a first housing and a second housing. The second housing is rotatably attached to the first housing. The second housing includes a first portion and a second portion. The second portion is attached to the first portion and has greater elasticity than the first portion. The second portion comprises a fingerhold.

### CROSS-REFERENCE TO RELATED APPLICATIONS

This application is based upon and claims the benefit of priority from Japanese Patent Application No. 2013-179861, filed Aug. 30, 2013, the entire contents of which are incorporated herein by reference.

### FIELD

Embodiments described herein relate generally to electronic apparatuses having a first housing and a second housing rotatable to the first housing.

### BACKGROUND

There is provided an electronic apparatus having a first housing and a second housing rotatable to the first housing, in which a rubber bumper is provided on the second housing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an electronic apparatus according to an embodiment.

FIG. 2 is an exemplary front view schematically illustrating a second portion including a fingerhold shown in FIG. 1.

FIG. 3 is an exemplary perspective view illustrating an enlarged region encircled by line F3 of the electronic apparatus shown in FIG. 1.

FIG. 4 is an exemplary side view illustrating a part of a first housing and a second housing shown in FIG. 1.

FIG. 5 is an exemplary side view illustrating a part of the second housing shown in FIG. 1.

FIG. 6 is an exemplary sectional view of the second housing shown in FIG. 1.

FIG. 7 is an exemplary front view illustrating an internal structure of an upper end of the second housing shown in FIG. 1.

FIG. 8 is an exemplary sectional view taken along line F8-F8 of the second housing shown in FIG. 7.

FIG. 9 is an exemplary sectional view taken along line F9-F9 of the second housing shown in FIG. 7.

FIG. 10 is an exemplary sectional view schematically illustrating that a mask of a structure shown in FIG. 9 is bent.

### DETAILED DESCRIPTION

Various embodiments will be described hereinafter with reference to the accompanying drawings.

In general, according to one embodiment, an electronic apparatus comprises a first housing and a second housing. The second housing is rotatably attached to the first housing. The second housing comprises a first portion and a second portion. The second portion is attached to the first portion and has greater elasticity than the first portion. The second portion comprises a fingerhold.

Some components are expressed by two or more terms. Those terms are just examples. Those components may be further expressed by another or other terms. And the other components which are not expressed by two or more terms may be expressed by another or other terms.

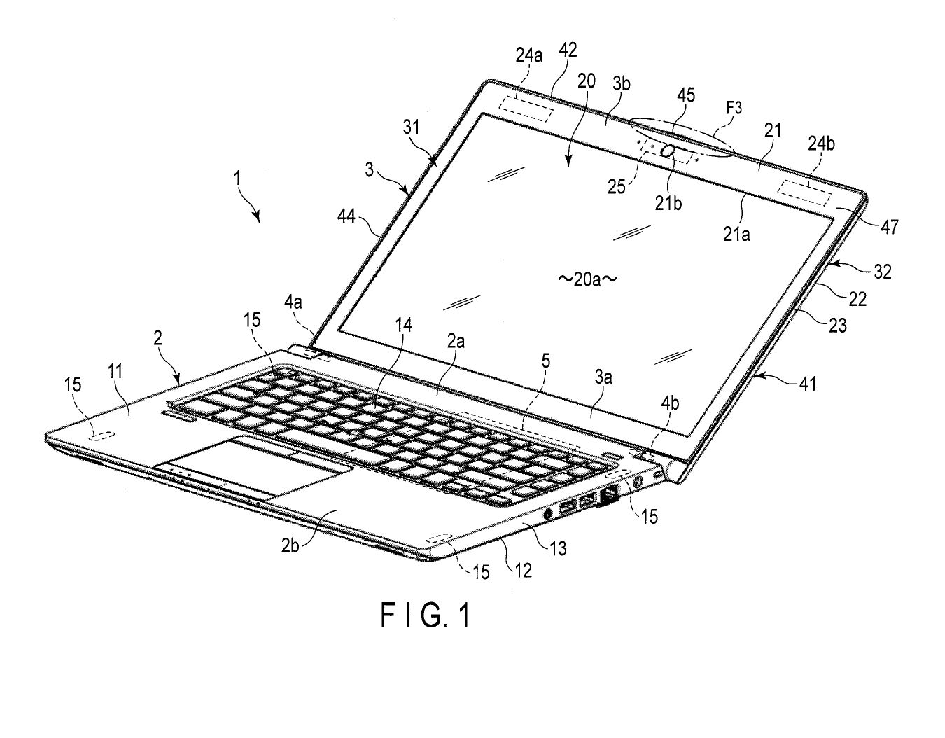

FIGS. 1 to 10 illustrate an electronic apparatus 1 according to an embodiment. The electronic apparatus 1 is, for example, a notebook portable computer (notebook PC). It should be noted that an electronic apparatus to which the present embodiment is applicable is not limited to this example. The present embodiment is widely applicable to various types of electronic apparatuses having a rotatable housing such as a cellphone and a game console.

As shown in FIG. 1, the electronic apparatus has a first housing 2, a second housing 3 and a pair of hinges 4a and 4b. The first housing 2 is, for example, a main housing. The first housing 2 accommodates, for example, a circuit board 5 as a main board.

The first housing 2 has an upper wall 11, a lower wall 12 (e.g., bottom wall) and a peripheral wall 13, formed into a flat box shape. It should be noted that, in the description that follows, upper, lower, left and right are defined from the point view of a user. Also, a location close to the user is defined as “front,” while a location distant from the user is defined as “rear.”

The upper wall 11 extends in a longitudinal direction (e.g., substantially horizontal direction) of the first housing 2. A keyboard 14 as an example of an input portion is provided on the upper wall 11. It should be noted that the input portion provided on the upper wall 11 may be, for example, a touchpanel (i.e., touchsensor) or other input apparatus, not limited to the keyboard 14.

The lower wall 12 is located opposite to the upper wall 11 and extends, for example, substantially parallel to the upper wall 11. When the electronic apparatus 1 is placed on a desk, the lower wall 12 faces the desk surface (i.e., external placement surface). The lower wall 12 has, for example, a plurality of legs 15 (i.e., supporting portions). When the electronic apparatus 1 is placed on a desk, the legs 15 contact the desk surface to support the electronic apparatus 1.

The peripheral wall 13 extends in a direction crossing the upper wall 11 and the lower wall 12 and connects the peripheral end of the lower wall 12 with that of the upper wall 11. The peripheral wall 13 extends in a thickness direction of the first housing 2. Also, the first housing 2 has a first end 2a (e.g., rear end) and a second end 2b (e.g., front end), which is located opposite to the first end 2a.

On the other hand, the second housing 3 is a display housing, for example. The second housing 3 accommodates a display 20 (i.e., display module or unit). An example of the display 20 is a liquid crystal display device, not limited thereto. The display 20 has a display screen 20a that displays an image.

The second housing 3 has a front wall 21 (i.e., lower wall or first wall), a back wall 22 (i.e., rear wall, upper wall or second wall) and a peripheral wall 23 (i.e., side wall or third wall), formed into a flat box shape. An opening 21a, through which the display screen 20a is exposed, is formed in the front wall 21. The back wall 22 is located opposite to the front wall 21, extending substantially parallel to the front wall 21. The back wall 22 covers the back face of the display 20. The peripheral wall 23 extends in a direction crossing the front wall 21 and the back wall 22 and connects the peripheral end of the front wall 21 with that of the back wall 22. The peripheral wall 23 is formed in a gentle circular arc shape from the end of the back wall 22 to the end of the front wall 21, for example.

The second housing 3 has a first end 3a (e.g., lower end) and a second end 3b (e.g., upper end), which is located opposite to the first end 3a. The second end 3b of the second housing 3 accommodates antennas 24a and 24b and a camera module 25. The front wall 21 has a hole 21b (e.g., imaging window, camera hole or opening), in which the camera (i.e., imaging section) of the camera module 25 is exposed to the outside. The hole 21b is located in a center portion of a width direction (e.g., horizontal direction) of the second housing 3.

The hinges 4a and 4b are rotatably attached (i.e., openable and closable) to the first end 2a of the first housing 2 and the first end 3a of the second housing 3. This makes the electronic apparatus 1 openable and closable (i.e., deformable or foldable). The second housing 3 is rotatable between a first state (e.g., closing state) and a second state (e.g., opening state) as mentioned below.

In the first state, the second housing 3 is laid on the first housing 2 so that the electronic apparatus 1 is closed. Specifically, the upper wall 11 of the first housing 2 and the front wall 21 of the second housing 3 face each other and the display screen 20a and the keyboard 14 are hidden from outside. On the other hand, in the second state, the second housing 3 is raised from the first housing 2 so that the electronic apparatus 1 is open. In the second state, the display screen 20a and the keyboard 14 are exposed to the outside.

Next, the structure of the second housing 3 will be described in detail.

As shown in FIG. 1, the second housing 3 has a mask 31 and a cover 32. The mask 31 is an example of a “first member.” The mask 31 faces the first housing 2 when the first housing 2 is laid on the second housing 3, for example, in the first state. The mask 31 includes the front wall 21, in which the opening 21a is formed. The cover 32 is an example of a “second member.” The cover 32 is located opposite to the mask 31 and includes the back wall 22 and the peripheral wall 23. The second housing 3 is formed in a combination of the mask 31 and the cover 32.

The second housing 3 has a first portion 41 and a second portion 42. The first portion 41 is a portion formed with, for example, hard plastic or metal. The first portion 41 includes a large part of the second housing 3. Specifically, the first portion 41 includes a large part of the mask 31 and the whole of the cover 32. The first portion 41 includes the front wall 21, the back wall 22 and the peripheral wall 23.

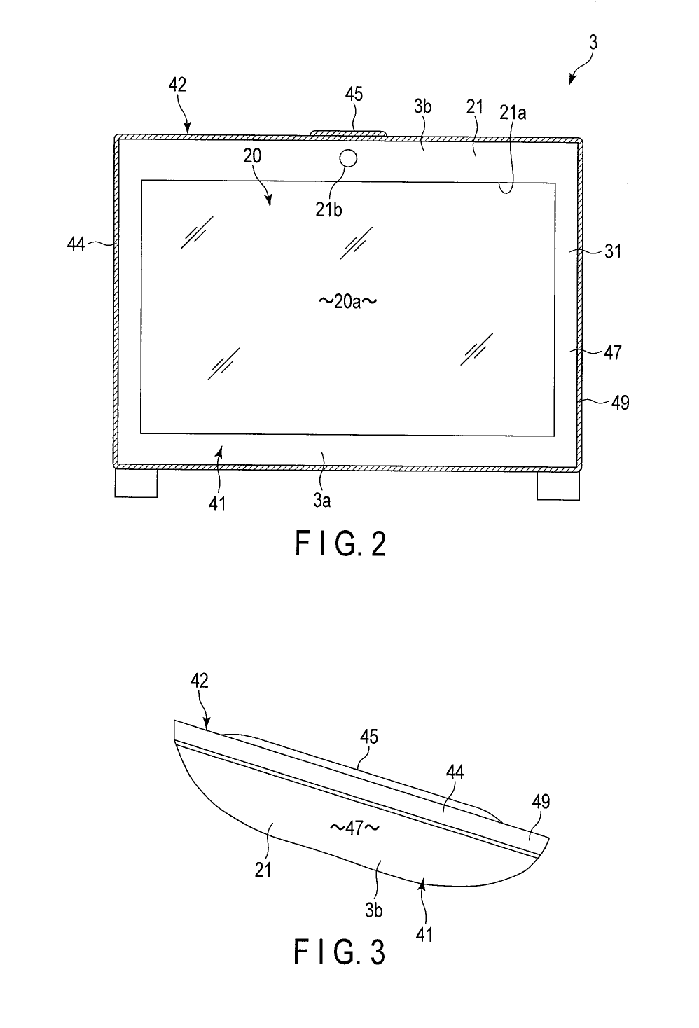

FIG. 2 shows the second portion 42 by hatching for convenience of explanation. The second portion 42 is more elastic and softer than the first portion 41. The second portion 42 is attached to the first portion 41. Specifically, the second portion 42 is provided on the mask 31. The second portion 42 includes a frame 44 along the peripheral end of the second housing 3 (e.g., the perimeter of the mask 31). The frame 44 is a relatively large frame body that surrounds the opening 21a through which the display screen 20a is exposed.

The second portion 42 is formed of, for example, an elastomer such as thermoplastic polyurethane elastomer (TPU). TPU is a type of plastic called urethane rubber or urethane resin and is a polymer which is as soft as rubber. TPU has the property of becoming softer, so more easily processed to a desired shape when heated to a certain temperature, and becoming harder when cooled. It should be noted that the material of the second portion 42 is not limited to the above examples.

As shown in FIG. 2 and FIG. 3, a fingerhold 45 (e.g., protruding fingerhold or tab), which enables the user to gain a fingerhold when the second housing 3 is rotated, is provided on the second portion 42. The fingerhold 45 is provided integrally with the frame 44 as a part of the second portion 42. That is, the fingerhold 45 is formed of the same material as the second portion 42. The second portion 42 including the fingerhold 45 is formed by double injection molding together with the resin of the first portion 41, for example.

The fingerhold 45 is located in the center portion of the second end 3b (e.g., upper end) of the second housing 3. The fingerhold 45 is a protrusion that protrudes from the frame 44. The fingerhold 45 protrudes toward the outside of the second housing 3 in a direction along the front wall 21. The fingerhold 45 has a predetermined length in a width direction (e.g., horizontal direction) of the second housing 3.

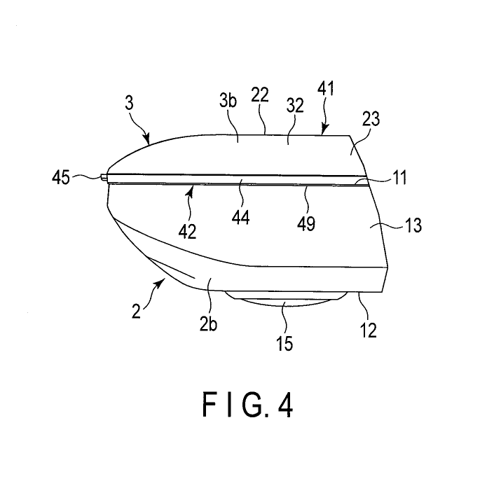

As shown in FIG. 4, the fingerhold 45 protrudes from the end surface of the first housing 2 (e.g., the edge of the front wall 21) in a direction crossing the rotational direction of the second housing 3 (e.g., in a direction along the upper wall 11 of the first housing 2), when the second housing 3 is laid on the first housing.

As shown in FIG. 1 and FIG. 4, the front wall of the first housing 2 extends linearly over almost the whole width of the horizontal direction of the first housing 2, and no hollow is arranged in a position corresponding to the fingerhold 45. This makes the appearance of the first housing 2 clear and improves the design of the electronic apparatus 1.

Next, the structure of the second portion 42 will be described in detail.

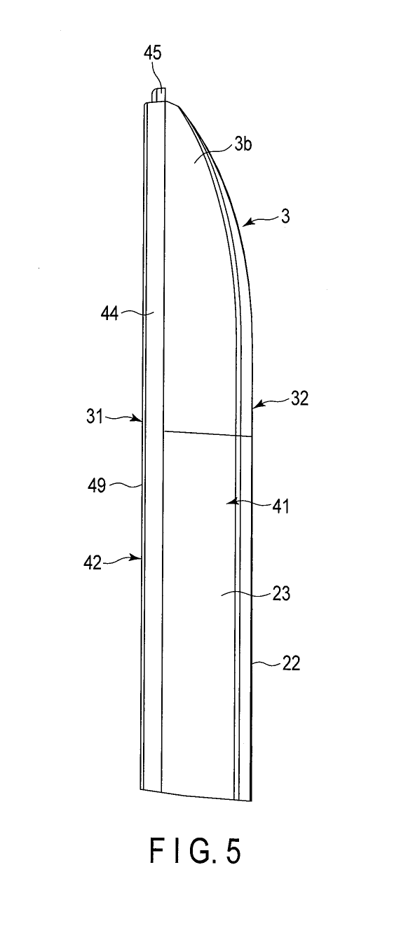

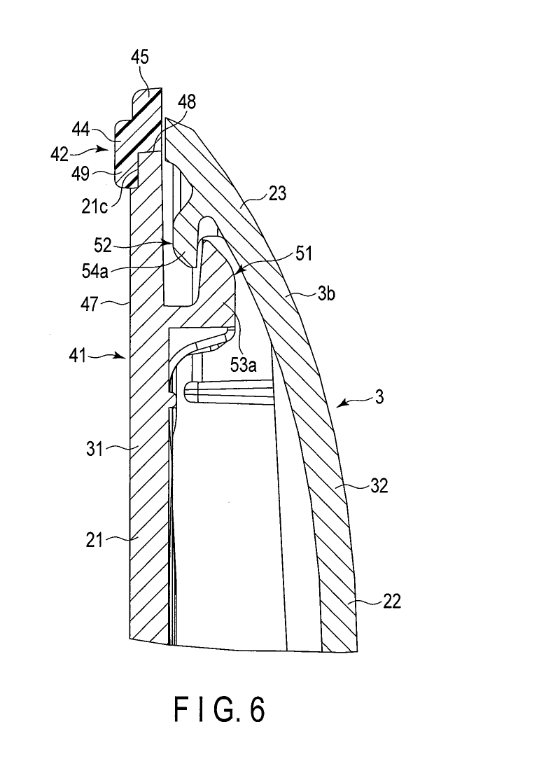

As shown in FIG. 2 and FIG. 5, the frame 44 is provided along the whole peripheral end of the front wall 21. As shown in FIG. 6, the peripheral end of the front wall 21 has a difference step part 21c. In the difference step part 21c, the surface of the front wall 21 is hollowed. The frame 44 is attached to the difference step part 21c and covers a front surface 47 and a side surface 48 of the perimeter of the front wall 21. That is, the frame 44 is formed in an L shape covering the peripheral end of the front wall 21 from the front to the side.

As shown in FIG. 6, the frame 44 has an abutting part 49 (i.e., cushion part) that protrudes to the front beyond the front surface 47 of the front wall 21. The abutting part 49 is formed in a frame along the whole perimeter of the second housing 3. The abutting part 49 is interposed between the first portion 41 of the second housing 3 and the first housing 2, when the second housing 3 and the first housing 2 are overlapped.

That is, the abutting part 49 is located adjacent to the first housing 2 as compared to the first portion of the second housing 3, when the second housing 3 and the first housing 2 are overlapped. The abutting part 49 may be contacted with the upper wall 11 of the first housing 2 or may be distant with a slight gap between the abutting part 49 and the upper wall 11 of the first housing 2, when the second housing 3 and the first housing 2 are overlapped.

By providing the abutting part 49, it can be avoided that the first portion 41 of the second housing 3 directly contacts the second housing 3 and that the keyboard 14 and the display screen 20a are damaged, when the second housing 3 and the first housing 2 are overlapped. Also, by providing the abutting part 49, the first housing 2 seems in close contact with the second housing 3 without any gap or position difference, and the appearance of the electronic apparatus 1 is improved, when the second housing 3 and the first housing 2 are overlapped.

As shown in FIG. 6, the fingerhold 45 is located on the extended line of the front wall 21. There are step differences between the fingerhold 45 and the abutting part 49. The fingerhold 45 is located adjacent to the cover 32 as compared to the abutting part 49. This makes the fingerhold 45 less conspicuous and improves the appearance of the electronic apparatus 1.

Next, the engagement structure of the mask 31 and the cover 32 will be described in detail.

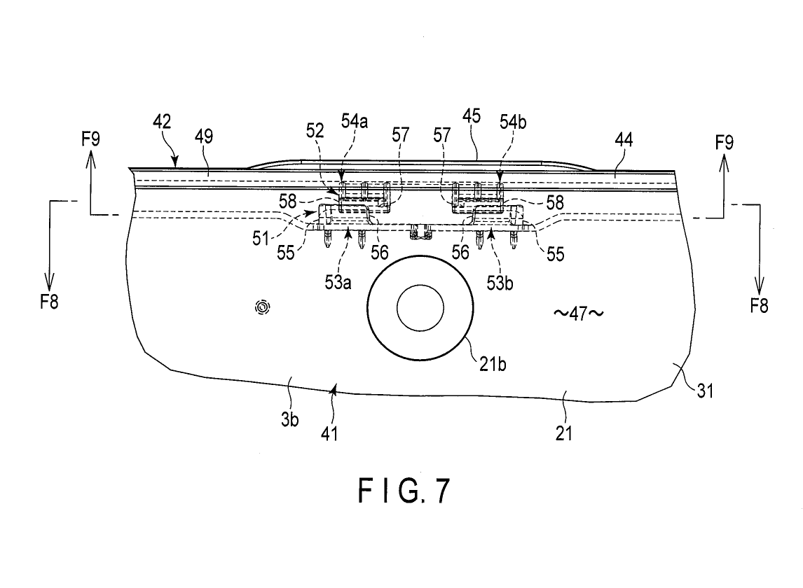

As shown in FIG. 6 and FIG. 7, the mask 31 has a first engaging part 51 in a region adjacent to the fingerhold 45. On the other hand, the cover 32 has a second engaging part 52, which engages with the first engaging part 51 when a force in a direction of disengaging the mask 31 from the cover 32 acts on the fingerhold 45. It should be noted that the second engaging part 52 may be always engaged (i.e., contacted) with the first engaging part 51, or that there may usually be a gap between the first engaging part 51 and the second engaging part 52 and the first engaging part 51 and the second engaging part 52 may be engaged (i.e., contacted) when an external force acts. By providing the first engaging part 51 and the second engaging part 52 as mentioned above, it can be avoided that a gap occurs in the boundary (e.g., joint surface) between the mask 31 and the cover 32 when the second housing 3 is closed.

More specifically, as shown in FIG. 7, the first engaging part 51 includes a pair of first hooks 53a and 53b (e.g., first pawl parts), each of which is located separately at the both sides of the center portion of the fingerhold 45 in a longitudinal direction of the fingerhold 45. The second engaging part 52 includes a pair of second hooks 54a and 54b (e.g., second pawl parts), each of which is located separately at both sides of the center portion of the fingerhold 45 in a longitudinal direction of the fingerhold 45 and engages with the pair of hooks 53a and 53b. The pair of second hooks 54a and 54b is located between the pair of first hooks 53a and 53b.

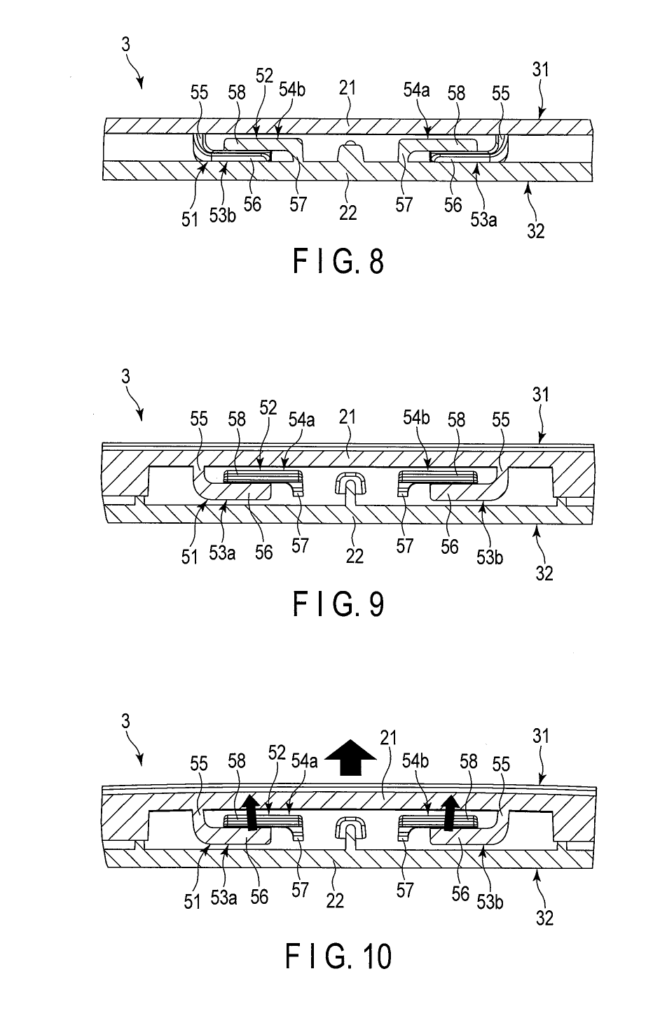

As shown in FIG. 8 and FIG. 9, the pair of first hooks 53a and 53b respectively has a base end 55 (i.e., supporting portion or first end) connected to the inner surface of the front wall 21 and a fore end 56 (i.e., engaging portion or second end) that extends from the base end 55 toward the center portion of the fingerhold 45 to engage with either of the second hook 54a or 54b. The pair of second hooks 54a and 54b respectively has a base end 57 (i.e., supporting portion or first end) connected to the inner surface of the front wall 21 and a fore end 58 (i.e., engaging portion or second end) that extends from the base end 57 to the first hooks 53a and 53b to engage with either the first hook 53a or 53b.

That is, the pair of first hooks 53a and 53b embraces the pair of second hooks 54a and 54b from outside. As will be mentioned in detail below, according to such a structure, when a force in a direction of closing the second housing 3 (i.e., a force in a direction opposite to a direction from the mask 31 toward the cover 32) is added to the fingerhold 45 to bend the mask 31, the engagement of the first engaging part 51 and the second engaging part 52 gets stronger. It should be noted that the number of the first hooks 53a and 53b and the second hooks 54a and 54b is not limited to two, respectively, and may be one, three or more.

According to such a structure, it is possible to improve design and to provide the durable electronic apparatus 1.

Generally, in an electronic apparatus, a finger recess is provided on a front end of a main unit so that a display unit can be opened easily. A user is able to gain a fingerhold on an end of the display unit by putting his fingertip in the recess. However, in such an electronic apparatus, since a recess is provided on a front end of a main unit, design and flexibility of the internal structure of the electronic apparatus can be diminished.

It is therefore suggested that a protrusion for gaining a fingerhold be provided in a display unit of an electronic apparatus. In this case, the protrusion is formed as a part of a housing of the display unit, for example. However, if the protrusion for gaining a fingerhold is formed of the same hard plastic as the housing of the display unit, for example, if a user inadvertently drops the electronic apparatus, an impact may be input from this protrusion and the display unit may be damaged.

The electronic apparatus 1 of the present embodiment has the first housing 2 and the second housing 3. The second housing 3 has the first portion 41 and the second portion 42, which is attached to the first portion 41 and has higher elasticity than the first portion 41, and is rotatably attached to the first housing 2. The fingerhold 45 is provided on the second portion 42.

According to such a structure, since the fingerhold 45 is provided on the second portion 42, which has higher elasticity than the first portion 41, even if a user inadvertently drops the electronic apparatus 1, for example, the fingerhold 45 can absorb a part of the impact. Therefore, it is possible to provide the more durable electronic apparatus 1. Also, by providing the fingerhold 45 on the second housing 3, the finger recess for fingerhold does not need to be provided in the first housing 2 and it is possible to improve design and flexibility of the internal structure of the electronic apparatus 1.

In the present embodiment, the second portion 42 including the fingerhold 45 is formed with elastomer, which makes it possible to impart appropriate elasticity and flexibility to the fingerhold 45. Also, the fingerhold 45 formed with elastomer (e.g., TPU) is less slippery and easy to operate. Therefore, it is also possible to improve operability of the electric apparatus 1.

In the present embodiment, the second portion 42 including the fingerhold 45 is formed by double injection together with the first portion 41. According to such a composition, the second portion 42 with different materials can be relatively easily provided integrally with the first portion 41. This realizes high manufacturability of the electronic apparatus 1 and can intend to reduce the cost of the electronic apparatus 1.

In the present embodiment, the second portion 42 includes the frame 44 along the peripheral end of the second housing 3. The fingerhold 45 is a protrusion that protrudes from the frame 44. According to such a structure, a force that acts on the fingerhold 45 can be received on the whole of the frame 44 (i.e., the whole of the second housing 3). Therefore, it can be avoided that loads concentrate in the fingerhold 45 or a part of the second housing 3 and the fingerhold 45 and a part of the second housing 3 are damaged.

In the present embodiment, the fingerfold member 45 protrudes beyond an end of the first housing 2 in a direction crossing a rotational direction of the second housing 3, when the second housing 3 is laid on the first housing 2. According to such a structure, it is easy to use the fingerfold 45 and operability of the electric device 1 can be further improved.

In the present embodiment, the second housing 3 has a first member (e.g., the mask 31) that faces the first housing 2 and a second member (e.g., the cover 32) that is combined with the first member and is located opposite to the first member, when the second housing 3 is laid on the first housing 2. The second portion 42 is provided on the first member.

According to such a structure, since a force from the fingerfold member 45 acts on the first member, a force does not work to disengage the first member from the second member when the second housing 3 is opened (when the second housing 3 is changed from the first state to the second state). Therefore, no gap occurs in the boundary (e.g., joint surface) between the first member and the second member.

On the other hand, when the second housing 3 is closed (when the second housing 3 is changed from the second state to the first state), a user often closes the second housing 3 by pushing the back surface of the second member (e.g., the back wall of the cover 32). Therefore, even when the second housing 3 is closed, it is often the case that a force does not work to disengage the first member from the second member. Thus, a gap hardly occurs in the boundary between the first member and the second member.

Next, a case will be explained where the second housing 3 is closed by the use of the fingerhold 45.

If the fingerhold 45 is formed with hard plastic, when a strong force acts on the fingerhold 45, it is likely that the first member is disengaged from the second member. However, in the present embodiment, since the fingerhold 45 has elasticity, even if a strong force acts on the fingerhold 45, a part of the force can be absorbed on the fingerhold 45. Therefore, even if a strong force acts on the fingerhold 45, the first member is less likely to be disengaged from the second member (i.e., a gap hardly occurs in the boundary between the first member and the second member) and the appearance of the electronic apparatus 1 can be improved.

In the present embodiment, the first member has the first engaging part 51 located in a region adjacent to the fingerhold 45. The second member has the second engaging part 52, which engages with the first engaging part 51 when a force in a direction of disengaging the first member from the second member acts on the fingerhold 45. According to such a structure, even when the second housing 3 is closed by the use of the fingerhold 45, the first member is less likely to be disengaged from the second member owing to the engagement of the first engaging part 51 and the second engaging part 52. Therefore, a gap hardly occurs in the boundary between the first member and the second member and the appearance of the electronic apparatus 1 can be improved.

In the present embodiment, the first engaging part 51 includes the pair of first hooks 53a and 53b located separately at both sides of the center portion of the fingerhold 45 in a longitudinal direction of the fingerhold 45. The second engaging part 52 includes the pair of second hooks 54a and 54b that engages with the pair of first hooks 53a and 53b. According to such a structure, even if the fingerhold 45 to be arranged is relatively wide, it is absolutely possible to maintain the engagement between the first member and the second member owing to the first engaging part 51 and the second engaging part 52. Therefore, since the first member is less likely to be disengaged from the second member (i.e., a gap hardly occurs in the boundary between the first member and the second member), the appearance of the electronic apparatus 1 can be improved.

In the present embodiment, the pair of second hooks 54a and 54b is located between the pair of first hooks 53a and 53b. The pair of first hooks 53a and 53b respectively has the base end 55 connected to the first member and the fore end 56 that extends from the base end 55 toward the center portion of the fingerhold 45 to engage with either of the second hook 54a or 54b. According to such a structure, it is possible to realize a structure where the second engaging part 52 is embraced from outside by the pair of first hooks 53a and 53b. Hereinafter, referring to FIG. 10, this structure will be described in detail.

FIG. 10 schematically shows that when the second housing 3 is closed, a force acts on the fingerhold 45 and the center portion of the first member gets bent. As shown in FIG. 10, in this case, the first member is deformed in a direction, in which the fore end 56 of the pair of first hooks 53a and 53b is pressed to the second hooks 54a and 54b. Therefore, when the second housing 3 is closed by the use of the fingerhold 45, if the first member gets bent, the engagement between the first engaging part 51 and the second engaging part 52 gets further stronger. Thus, the engagement between the first hooks 53a and 53b and the second hooks 54a and 54b is absolutely maintained. Accordingly, since the first member is much less likely to be disengaged from the second member (i.e., a gap hardly occurs in the boundary between the first member and the second member), the appearance of the electronic apparatus 1 can be improved.

In the present embodiment, the hole 21b, in which the camera of the camera module 25 is exposed, is arranged on the first member. If the fingerhold 45 is arranged on the second member, the middle of the camera hole 21b and the middle of the fingerhold 45 are likely to be misaligned due to component tolerance or assembly tolerance of the first member and the second member, and the appearance of the electronic apparatus 1 may be marred. However, in the present embodiment, since the camera hole 21b and the fingerhold 45 are both arranged on the first member, the center of the camera hole 21b and the center of the fingerhold 45 are less likely to be misaligned and the appearance of the electronic apparatus 1 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the material of the fingerhold 45 is not limited to TPU and may be a material that is more elastic than hard plastic without any restriction. The second portion 42 is not limited to the one including the frame 44 along the peripheral end of the second housing 3. For example, the second portion 42 may be the linear one extending along the second end 3b of the second housing 3 or other configurations. The second portion 42 is not limited to the one provided on the mask 31 and may be provided on the cover 32. The configurations of the first hooks 53a and 53b and second hooks 54a and 54b are not limited to the particular ones. For example, the pair of first hooks 53a and 53b may be located between the pair of second hooks 54a and 54b and may be the one embraced from outside by the second hooks 54a and 54b.

What is claimed is:

1. An electronic apparatus comprising:
a first housing; and
a second housing rotatably attached to the first housing, the second housing comprising a first portion attached to a second portion, the second portion having greater elasticity than the first portion,
wherein the second portion comprises a fingerhold.

2. The electronic apparatus of claim 1, wherein
the second portion further comprises a frame along a peripheral end of the second housing, and
the fingerhold is a protrusion protruding from the frame.

3. The electronic apparatus of claim 1, wherein
the fingerhold protrudes beyond an end of the first housing in a direction crossing a rotational direction of the second housing when the second housing is on the first housing.

4. The electronic apparatus of claim 1, wherein
the second housing has a first member and a second member, the first member configured to face the first housing when the second housing is on the first housing, the second member combined with the first member and located opposite to the first member, and
the first member comprises the second portion.

5. The electronic apparatus of claim 4, further comprising a display in the second housing,
wherein the first member is a mask comprising an opening configured to expose a display screen of the display, and the second member is a cover configured to cover a back face of the display.

6. The electronic apparatus of claim 4, wherein
the first member comprises a first engaging part in a region adjacent to the fingerhold, and
the second member comprises a second engaging part configured to engage with the first engaging part when a force in a direction of disengaging the first member from the second member acts on the fingerhold.

7. The electronic apparatus of claim 6, wherein
the first engaging part comprises a pair of first hooks located separately at both sides of the fingerhold in a longitudinal direction of the fingerhold, and
the second engaging part comprises a pair of second hooks configured to engage with the pair of first hooks.

8. The electronic apparatus of claim 7, wherein
the pair of second hooks is located between the pair of first hooks, and
each of the pair of first hooks comprises a first end connected to the first member and a second end extending from the first end toward a center portion of the fingerhold to engage with either of the pair of second hooks.

9. The electronic apparatus of claim 1,
wherein the second portion comprising the fingerhold is formed with elastomer.

10. The electronic apparatus of claim 1,
wherein the second portion comprising the fingerhold is formed by double injection together with the first portion.
